(19) United States
(12) Patent Application Publication
(10) Pub. No.: US 2025/0317341 A1
(43) Pub. Date: Oct. 9, 2025

(54) SYSTEM AND METHOD FOR CREST FACTOR REDUCTION WITH A RESTRICTED PEAK REGROWTH

(71) Applicant: JIO PLATFORMS LIMITED, Ahmedabad (IN)

(72) Inventors: Gaurav DALWADI, Navi Mumbai (IN); Navaneeth KRISHNAN, Malappuram (IN); Brijesh I. SHAH, Navi Mumbai (IN)

(73) Assignee: JIO PLATFORMS LIMITED, Ahmedabad (IN)

(21) Appl. No.: 18/864,957

(22) PCT Filed: May 12, 2023
(86) PCT No.: PCT/IB2023/054913

§ 371 Date: Nov. 12, 2024

(30) Foreign Application Priority Data
May 12, 2022 (IN) 202221027468

(51) Int. Cl. H04L 27/26

(52) U.S. Cl. CPC H04L 27/2623

(57) ABSTRACT

The present disclosure provides a system and a method for crest factor reduction (CFR) with a restricted peak regrowth. The system receives a complex signal from a physical layer (PHY) of a base station equipped with orthogonal frequency division multiplexing (OFDM). The system uses a coordinate rotation digital computer (CORDIC) to convert the complex signal into a polar form. Further, the system utilizes an advanced interpolation processing (AIP) technique to minimize the peak regrowth that can happen in an x4 (digital up-conversion (DUC) in the later stage of a downlink chain. Hence, a teething problem of peak growth due to DUC process is restricted to a limited regrowth in the proposed CFR design. Further, the CFR design can operate multiple multiple-input multiple-output (MIMO) channels by multiplexing in time domain which further reduces resource utilization.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for orthogonal frequency division multiplexing (OFDM) based communication technology in a telecommunications network. More particularly, the present disclosure relates to a system and a method for crest factor reduction with a restricted peak regrowth.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Orthogonal frequency division multiplexing (OFDM) based communication technology implemented in a long-term evolution (LTE) and a 5th generation new radio (5G NR) are widely adopted to meet a high data rate, a high throughput, and a reliable network access.

OFDM includes a higher peak to average power ratio (PAPR) than single carrier systems due to a non-constant envelope. The main reason for this is due to a fact that sums of multiple sub-carriers create a compound signal where real and imaginary parts approach a Gaussian Probability Density Function (PDF) due to the Central Limit Theorem, whereas the amplitude approaches a Rayleigh PDF. This increase in the PAPR results in the reduction of the efficiency of a power amplifier (PA). Hence, a high PAPR of the OFDM limits the efficiency of the PA in a conventional massive multiple-input multiple-output (MIMO) 5G NR system.

Conventional systems include high resource utilization and a PAPR performance for wider channel bandwidth such as 100 Mega Hertz (MHz). Further, Field Programmable Gate Arrays (FPGAs) with resource constraints may pose additional problems due to a large number of transmit chains involved in the massive MIMO system used in the 5G NR. Moreover, high speed radio frequency (RF) data converters widely used in the 5G NR design may utilize a higher sampling clock for converting digital data into an RF analog signal. Also, the RF data converters may require digital up-conversion (DUC) of data output obtained from a physical layer leading to a peak regrowth.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that uses mixed and multi-iterative signal distortion-based approaches ranging from a low bandwidth to a large bandwidth up to 100 Mega Hertz (MHz) for single carrier and up to 200 MHz for multicarrier for a fifth generation (5G) new radio (NR) signal.

It is an object of the present disclosure to provide a system and a method that reduces a high peak to average power ratio (PAPR) associated with orthogonal frequency division multiplexing (OFDM) based communication technology.

It is an object of the present disclosure to provide a system and a method that utilizes a crest factor reduction (CFR) technique to reduce the PAPR.

It is an object of the present disclosure to provide a system and a method that uses the CFR technique to operate at a low data rate before digital up-conversion (DUC) and restricts a peak regrowth associated with the PAPR reduction achieved by CFR processing.

It is an object of the present disclosure to provide a system and a method that processes various Field Programmable Gate Array (FPGA) implementation challenges and optimizes the CFR design with low resource utilization.

It is an object of the present disclosure to provide a system and a method that provides a mixed peak cancellation (PC) and a peak windowing (PW) based CFR technique for a 5G NR digital front-end (DFE) design via PAPR reduction performance, full bandwidth utilization, and negligible computational complexity.

It is an object of the present disclosure to provide a system and a method that uses the CFR design with a low complexity solution providing effective PAPR performance and the required restricted peak regrowth.

It is an object of the present disclosure to provide a system and a method that uses an advanced interpolation processing (AIP) technique to remove the peak regrowth observed in the DUC in the later stage of the downlink chain.

It is an object of the present disclosure to provide a system and a method that uses a dual port read-only memory (ROM) for cancellation pulse coefficient storage, which can reduce the block random access memory (BRAM) resource usage to a large extent.

It is an object of the present disclosure to provide a system and a method that operates multiple massive multiple-input multiple-output (MIMO) channels by multiplexing in a time domain and further reduces resource utilization.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a crest factor reduction (CFR) system with a restricted peak regrowth. The system may include a processor operatively coupled with a memory that stores instructions to be executed by the processor. The processor may receive a signal from a physical layer (PHY) of a new radio (NR) equipped with orthogonal frequency division multiplexing (OFDM). The received signal may be based on a complex low peak to average power ration (PAPR) signal. The processor may interpolate the received signal to an n-factor to generate the received signal with a pre-determined peak regrowth. The processor may generate one or more pulses to negate a peak associated with the pre-determined peak regrowth of the received signal to generate a modified n-factor signal. The processor may decimate the modified n-factor signal to generate a PAPR diminished signal prior to a digital up-conversion (DUC) and generate the CFR with the restricted peak regrowth.

In an embodiment, the processor may be configured with a coordinate rotation digital computer (CORDIC) technique to determine a magnitude and a phase associated with the received signal.

In an embodiment, the processor may be configured to generate a peak search window (PSW) associated with the magnitude and the phase of the received signal.

In an embodiment, the processor may be configured with a peak cancellation (PC) technique that provides multiplexing of the received signal and generates the PSW.

In an embodiment, the processor may be configured with an advanced interpolation processing (AIP) technique for the generation of the received signal with the pre-determined peak regrowth.

In an embodiment, the AIP technique may use a Finite Impulse Response (FIR) based interpolator for the generation of the received signal with the pre-determined peak regrowth.

In an embodiment, the processor may include a down sampler for the decimation of the modified n-factor signal.

In an embodiment, the down sampler may subtract the modified n-factor signal from the received signal for the generation of the PAPR diminished signal.

In an embodiment, the processor may be configured with a window crest factor reduction (WCFR) technique to sanitize the negated peaks associated with the received signal.

In an embodiment, the processor may be configured with a dual port read only memory (DPROM) to store the sanitized negated peak.

In an aspect, the present disclosure relates to a method for CFR with a restricted peak regrowth. The method may include receiving, by a processor, a signal from a PHY of a NR equipped with OFDM. The received signal may be based on a complex PAPR signal. The method may include interpolating, by the processor, the received signal to an n-factor for generating the received signal with a pre-determined peak regrowth. The method may include generating, by the processor, one or more pulses to negate a peak associated with the pre-determined peak regrowth of the received signal for generating a modified n-factor signal. The method may include decimating, by the processor, the modified n-factor signal to generate a PAPR diminished signal prior to a DUC and generating the CFR with the restricted peak regrowth.

In an embodiment, the method may include determining, by the processor, a magnitude and a phase associated with the received signal via a CORDIC technique.

In an embodiment, the method may include generating, by the processor, a PSW associated with the magnitude and the phase of the received signal.

In an embodiment, the method may include multiplexing, by the processor, the received signal for generating the PSW via a PC technique.

In an embodiment, the method may include generating, by the processor, the received signal with the pre-determined peak regrowth with an AIP technique.

In an aspect, a non-transitory computer readable medium may include a processor with executable instructions that may cause the processor to receive a signal from a PHY of a NR equipped with OFDM. The received signal may be based on a complex PAPR signal. The processor may interpolate the received signal to an n-factor to generate the received signal with a pre-determined peak regrowth. The processor may generate one or more pulses to negate a peak associated with the pre-determined peak regrowth of the received signal to generate a modified n-factor signal. The processor may decimate the modified n-factor signal to generate a PAPR diminished signal prior to a DUC and generate the CFR with the restricted peak regrowth.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (110), in accordance with an embodiment of the present disclosure.

FIG. 2 illustrates an exemplary block diagram (200) of a proposed system (110), in accordance with an embodiment of the present disclosure.

FIG. 3 illustrates an exemplary crest factor reduction (CFR) design (300) with a combined peak cancellation (PC) and a peak windowing (PW) CFR, in accordance with an embodiment of the present disclosure.

FIG. 4 illustrates an exemplary clip stage (400) of the PC CFR technique, in accordance with an embodiment of the present disclosure.

FIG. 5 illustrates an exemplary flow diagram (500) of an algorithmic state machine (ASM), in accordance with an embodiment of the present disclosure.

FIG. 6 illustrates an exemplary peak manager (600) of the PC CFR technique, in accordance with an embodiment of the present disclosure.

FIG. 7 illustrates an exemplary representation (700) of the PW CFR technique, in accordance with an embodiment of the present disclosure.

FIG. 8 illustrates an exemplary complementary cumulative distribution function (CCDF) plot (800) of CFR output, in accordance with an embodiment of the present disclosure.

FIG. 9 illustrates an exemplary fifth generation (5G) signal comparison (900) before and after CFR, in accordance with an embodiment of the present disclosure.

FIG. 10 illustrates an exemplary CCDF plot (1000) of digital up-conversion (DUC) output at x2, in accordance with an embodiment of the present disclosure.

FIG. 11 illustrates an exemplary CCDF plot (1100) of DUC output at x4, in accordance with an embodiment of the present disclosure.

FIG. 12 illustrates an exemplary peak analysis (1200) with an input signal and output signal with CFR at x1, in accordance with an embodiment of the present disclosure.

FIG. 13 illustrates an exemplary peak analysis (1300) at x2, x4 outputs, in accordance with an embodiment of the present disclosure.

FIG. 14 illustrates an exemplary modified clip stage (1400) with an advanced interpolation processing (AIP) module in the proposed CFR, in accordance with an embodiment of the present disclosure.

FIG. 15 illustrates an exemplary CCDF plot (1500) of CFR output at x1 with AIP, in accordance with an embodiment of the present disclosure.

FIG. 16 illustrates an exemplary CCDF plot (1600) of x4 DUC output with AIP, in accordance with an embodiment of the present disclosure.

FIG. 17 illustrates an exemplary 5G signal comparison (1700) before and after CFR with AIP, in accordance with an embodiment of the present disclosure.

FIG. 18 illustrates an exemplary peak analysis (1800) of an input signal and output signal at x1 with AIP, in accordance with an embodiment of the present disclosure.

FIG. 19 illustrates an exemplary peak analysis (1900) at x2 DUC output and x4 DUC output with AIP, in accordance with an embodiment of the present disclosure.

FIG. 20 illustrates an exemplary hardware block diagram (2000) of the AIP integrated CFR, in accordance with an embodiment of the present disclosure.

FIG. 21 illustrates an exemplary computer system (2100) in which or with which embodiments of the present disclosure may be implemented.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

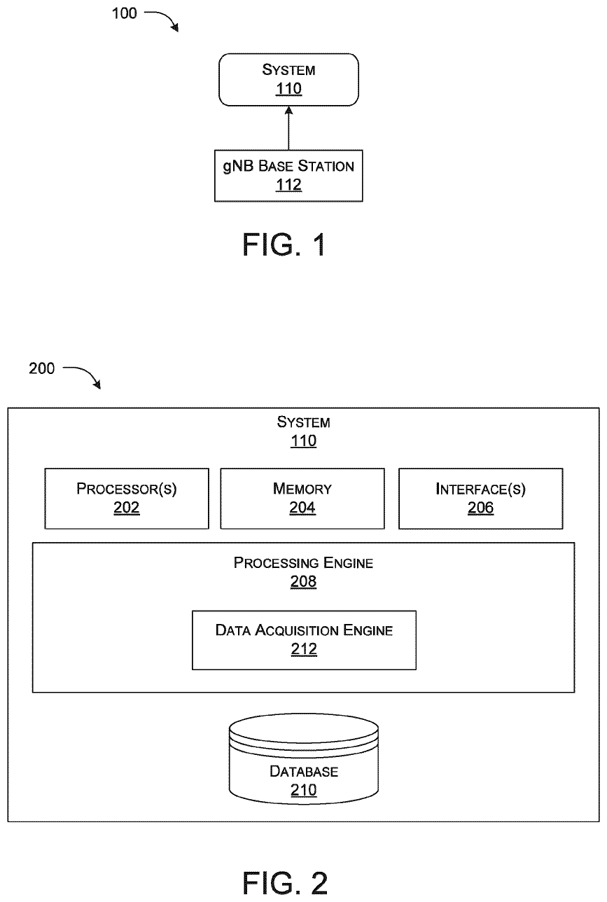

The various embodiments throughout the disclosure will be explained in more detail with reference to FIGS. 1-21.

FIG. 1 illustrates an exemplary network architecture (100) of a proposed system (110), in accordance with an embodiment of the present disclosure.

As illustrated in FIG. 1, the network architecture (100) may include a system (110). The system (110) may be connected to a digital front end (DFE) of a gNB base station (112). In an embodiment, the system (110) may receive a signal from a physical layer (PHY) of a new radio (NR)/gNB base station (112) equipped with orthogonal frequency division multiplexing (OFDM). The received signal may be based on a complex low peak to average power ration (PAPR) signal.

In an embodiment, the gNB base station (112) may include a 5G NR massive multiple-input multiple-output (MIMO) radio unit (MRU) which may be a 200 W high power gNB that operates in macro class (typically 6.25 W or 38 dBm per antenna port). The gNB base station (112) may provide macro-level wide-area solutions for coverage and capacity and may be particularly useful in dense urban morphologies, hot zone/hot spot areas with high traffic, and quality of service (QOS) demands. The gNB base station (112) may further include a lower layer PHY section and a radio frequency (RF) transceiver based on commercial grade Field Programmable Gate Arrays (FPGAs) with transmit and receive chains. The gNB base station (112) may include a RF front end module (RFEM) that includes RF power amplifiers, low noise amplifiers (LNA), RF switches, and an Antenna Filter Unit (AFU).

In an embodiment, digital up-conversion (DUC) used to achieve the required high sample rate may generate a peak regrowth even after required PAPR reduction is achieved by crest factor reduction (CFR) processing. Hence, the system (110) may incorporate a CFR methodology that may operate at a low data rate before DUC and restrict the peak regrowth.

In an embodiment, the system (110) may use, but not limited to, a mixed peak cancellation (PC) and peak windowing (PW) based CFR technique for 5G NR DFE design because of effective PAPR reduction performance, full bandwidth utilization, ease of implementation, and negligible computational complexity.

In an embodiment, the system (110) may utilize a coordinate rotation digital computer (CORDIC) technique to determine a magnitude and a phase associated with the received signal. Further, the system (110) may generate a peak search window (PSW) associated with the magnitude and the phase of the received signal. The system (110) may use a peak cancellation (PC) technique that provides multiplexing of the received signal and generate the PSW.

Further, in an embodiment, the system (110) may interpolate the received signal to an n-factor to generate the received signal with a pre-determined peak regrowth. The system (110) may use an advanced interpolation processing (AIP) technique for the generation of the received signal with the pre-determined peak regrowth. The AIP may include a Finite Impulse Response (FIR) based interpolator for the generation of the received signal with the pre-determined peak regrowth.

In an embodiment, the system (110) may generate one or more pulses to negate a peak associated with the pre-determined peak regrowth of the received signal to generate a modified n-factor signal. Further, in an embodiment, the system (110) may utilize a window crest factor reduction (WCFR) technique to sanitize the negated peak associated with the received signal.

In an embodiment, the system (110) may decimate the modified n-factor signal to generate a PAPR diminished signal prior to a DUC and generate the CFR with the restricted peak regrowth.

In an embodiment, the system (110) may use a down sampler for the decimation of the modified n-factor signal. Further, the down sampler may subtract the modified n-factor signal from the received signal for the generation of the PAPR diminished signal.

In an embodiment, the system (110) may utilize various CFR techniques including coding-based CFR techniques such as, but not limited to, precoding, block coding, convolution coding, and concatenate coding. Further, signal scrambling or probabilistic method-based CFR techniques may be used including, but not limited to, selected mapping, partial transmit sequence, tone injection, tone reservation, interleaving, and dummy sequence insertion. Also, signal distortion method based CFR techniques such as, but not limited to, hard clipper based CFR, clipping and filtering CFR, PW, PC, and nonlinear compounding may be incorporated by the system (110).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

FIG. 2 illustrates an exemplary block diagram (200) of a proposed system (110), in accordance with an embodiment of the present disclosure.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (110). Examples of such components include, but are not limited to, processing engine(s) (208) and a database (210), where the processing engine(s) (208) may include, but not limited to, a data acquisition engine (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the processor (202) may utilize the data acquisition engine (212) to receive a signal from a PHY of an NR equipped with OFDM. The processor (202) may store information corresponding to the received signal in the database (210). The received signal may be based on a complex low PAPR signal.

In an embodiment, the processor (202) may utilize a CORDIC technique to determine a magnitude and a phase associated with the received signal. Further, the processor (202) may generate a PSW associated with the magnitude and the phase of the received signal. The processor (202) may use a PC technique that provides multiplexing of the received signal and generate the PSW.

In an embodiment, the processor (202) may interpolate the received signal to an n-factor to generate the received signal with a pre-determined peak regrowth. The processor (202) may utilize an AIP technique for the generation of the received signal with the pre-determined peak regrowth. The AIP may include an FIR based interpolator for the generation of the received signal with the pre-determined peak regrowth.

In an embodiment, the processor (202) may generate one or more pulses to negate a peak associated with the pre-determined peak regrowth of the received signal to generate a modified n-factor signal. Further, the processor (202) may utilize a WCFR technique to sanitize the negated peak associated with the received signal. The processor (202) may use a DPROM to store the sanitized negated peaks.

In an embodiment, the processor (202) may decimate the modified n-factor signal to generate a PAPR diminished signal prior to a DUC and generate the CFR with the restricted peak regrowth. Further, the processor (202) may use a down sampler for the decimation of the modified n-factor signal. The down sampler may subtract the modified n-factor signal from the received signal for the generation of the PAPR diminished signal.

Although FIG. 2 shows exemplary components of the system (110), in other embodiments, the system (110) may include fewer components, different components, differently arranged components, or additional functional components than depicted in FIG. 2. Additionally, or alternatively, one or more components of the system (110) may perform functions described as being performed by one or more other components of the system (110).

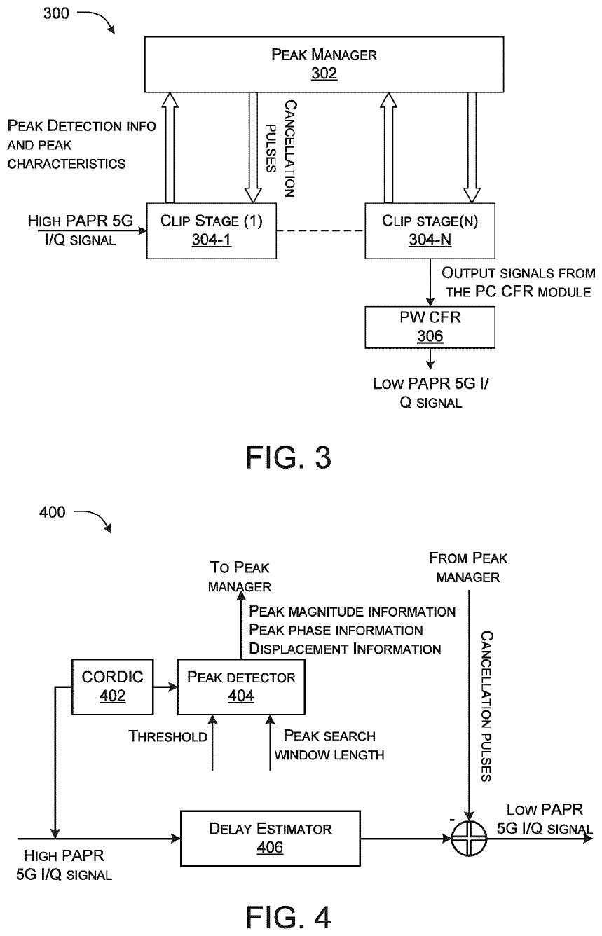

FIG. 3 illustrates an exemplary CFR design (300) with a combined PC and a PW CFR, in accordance with an embodiment of the present disclosure.

As illustrated in FIG. 3, the CFR design (300) may include cascaded stages of conventional PC and PW CFR modules. In an embodiment, the CFR design (300) may include a peak manager (302), clip stages (304-1 to 304-N), and a PW CFR (306).

In an embodiment, the clip stages (304-1 to 304-N) may receive a high PAPR input signal from a gNB base station (e.g., 112 of FIG. 1). In an embodiment, the peak manager (302) may receive peak detection information and peak characteristics from the clip stages (304-1 to 304-N). Further, the peak manager (302) may generate peak cancellation pulses towards the high PAPR input signal received from the clip stages (304-1 to 304-N) and further generate an output signal. The peak manager (302) may generate the low PAPR signal via the PW CFR (306).

FIG. 4 illustrates an exemplary clip stage (400) of the PC CFR, in accordance with an embodiment of the present disclosure.

As illustrated in FIG. 4, in an embodiment, the clip stage (400) may consist of CORDIC (402) followed by a peak detector (404). A delay estimator (406) circuit may delay an unscaled input to be subtracted with cancellation pulses obtained from the peak manager (e.g., 302 of FIG. 3). The input of the clip stage (400) may be a complex 5G NR signal in a polar form. This signal may be converted into the rectangular form to represent the peak. The CORDIC (402) may be a flexible iterative technique capable of computing several approximated transcendental functions without the need of multipliers and may be used in hardware design in order to minimize the area.

In an embodiment, the output of the CORDIC (402) may be forwarded to the peak detector (404), where the peak detector (404) may find the peak in each interval of the samples collectively known as a PSW. Further, characteristics of the peak may be passed to the peak manager (302) section. The peak detector (404) may also collect data on the height of the detected peaks where the data may be utilized for statistical purposes or for applying adjustments on a threshold and measuring the PSW length.

In an embodiment, the output signal may be processed by a PW CFR module (e.g., 306 of FIG. 3) to generate a low 5G PAPR signal.

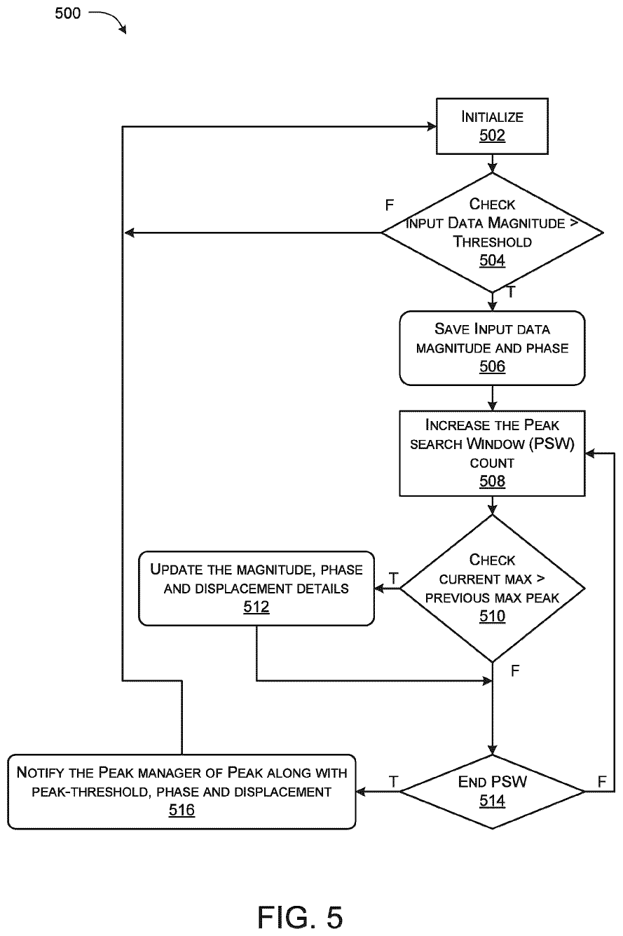

FIG. 5 illustrates an exemplary flow diagram (500) of an algorithmic state machine (ASM), in accordance with an embodiment of the present disclosure.

As illustrated in FIG. 5, the following steps may be utilized by the ASM.

At step 502: The ASM may be initialized.

At step 504: The ASM may determine if input magnitude of the received signal may be greater than a threshold.

At step 506: Based on a positive determination obtained from step 504, the ASM may save input data/signal with a corresponding magnitude and phase. Based on a negative determination obtained from step 504, the ASM may go back to step 502.

At step 508: The ASM may increase the PSW count.

At step 510: The ASM may determine if a current maximum peak is greater than a previous maximum peak.

At step 512: Based on a positive determination obtained from step 510, the ASM may update the magnitude, phase, and displacement details.

At step 514: Based on a negative determination obtained from step 510, the ASM may determine if PSW has ended.

At step 516: Based on a positive determination obtained from step 514, the ASM may notify the peak manager (e.g., 302) of the peak threshold, phase, and displacement details, and further continue with step 502. Based on a negative determination obtained from step 514, the ASM may resume step 508.

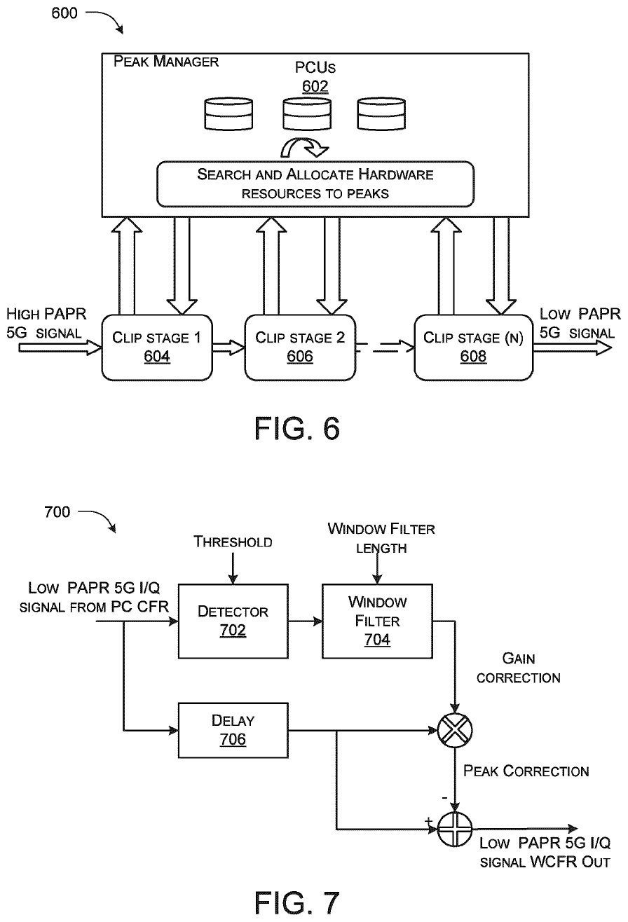

FIG. 6 illustrates an exemplary peak manager (600) of the PC CFR, in accordance with an embodiment of the present disclosure.

As illustrated in FIG. 6, the peak manager (600) of the PC CFR may be a centralized unit that receives notifications and characteristics of detected peaks from all clip stages (604 to 608), generates cancelling pulses accordingly, and sends them back to the appropriate clip stage, where cancellation of peaks may occur. The important unit of the peak manager (600) may be the peak cancellation unit (PCU) (602), where the efficiency of the PCU (602) determines the overall efficiency of the PC CFR unit. The PCUs (602) may work in parallel and generate the cancellation pulses which may be later subtracted from the actual unscaled input signal. Whenever a peak information is passed to the peak manager (600), the peak manager (600) may determine whether any PCUs (602) are free and enable assignment of peaks and record the unassigned peaks into a peak list. The peak manager (600) may work in a shared manner to reduce the resource utilization, i.e. the same peak manager (600) may be shared between multiple clip stages.

FIG. 7 illustrates an exemplary representation (700) of the PW CFR, in accordance with an embodiment of the present disclosure.

As illustrated in FIG. 7, the PW CFR may operate by attenuating the received low PAPR 5G signal from the PC CFR at peaks over the threshold and may be agnostic to the carrier configuration of the input signal. The length of the filter (704) may set the amount of spreading of the signal in the frequency domain. If the filter (704) is made very long, then the splatter may be reduced but an added error vector magnitude (EVM) may become larger. Thus, there may be a trade-off between an adjacent channel leakage ration (ACLR) and the EVM in window length selection. However, a WCFR may ensure that no peaks are passed on unlike pulse cancellation methods. However, the WCFR may generally have a lower performance than the PC CFR. The degradation may be proportional to the number of peaks that must be cancelled. Therefore, the WCFR may include an ideal processing stage where the numbers of peaks are small such that little degradation occurs without a peaks escape cancellation. The current implementation supports WCFR as a post-processing stage which further helps in controlling peak EVM and reducing PC CFR iterations. The WCFR may be a necessary post-processing stage when smart peak processing is enabled to improve the PAPR by cleaning up any leftover peak after cancellation.

In an embodiment, as illustrated in FIG. 7, the detector (702) may receive the low PAPR 5G signal from the PC CFR. Based on the threshold, the detector (702) may negate the peaks associated with the low PAPR 5G signal and process the low PAPR 5G signal. A window filter module (704) may filter the processed low PAPR 5G signal. Further, the unscaled low PAPR signal may be passed through a delay module (706) to generate a predetermined delay associated with the unscaled low PAPR signal. The filtered processed low PAPR 5G signal with the required gain correction may be subtracted from the unscaled low PAPR signal. Hence, a low PAPR 5G signal me be generated by the WCFR with the required peak correction.

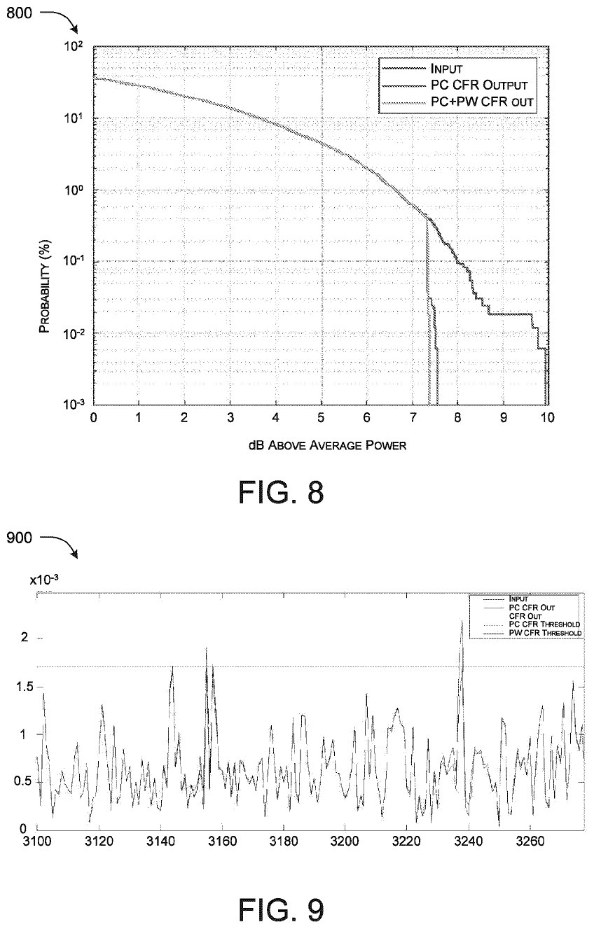

FIG. 8 illustrates an exemplary complementary cumulative distributive function (CCDF) plot (800) of CFR output, in accordance with an embodiment of the present disclosure.

As illustrated in FIG. 8, the PC CFR may generate a correction of 4.4 decibels (dB) i.e., from 9.93 dB to 7.5 dB in PAPR. Further the PW CFR may clip out the extra peaks and generate the correction down to 7.38 dB.

FIG. 9 illustrates an exemplary 5G signal comparison (900) before and after CFR, in accordance with an embodiment of the present disclosure.

As illustrated in FIG. 9, a comparison of various 5G signals before incorporating CFR and after incorporating CFR may be observed. Amplitudes of the various 5G signals may be analyzed with respect to CFR incorporation.

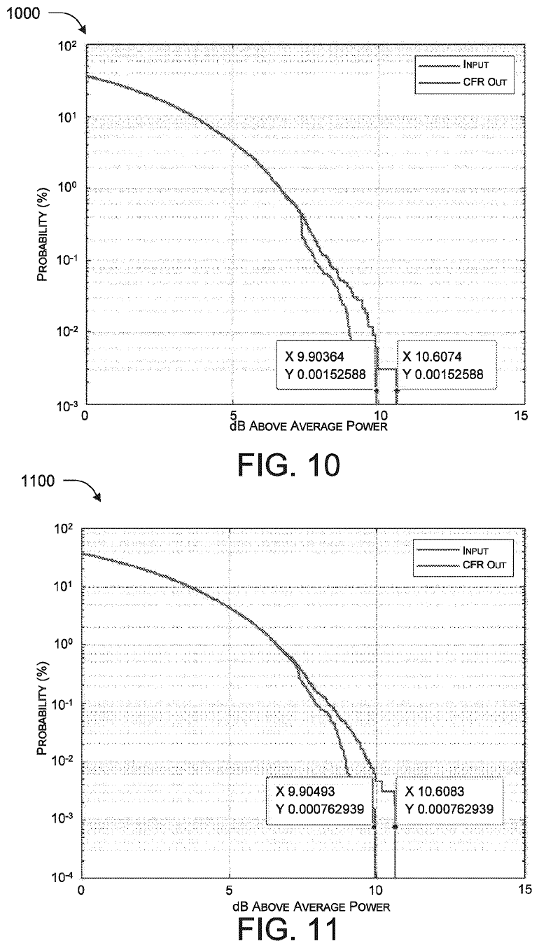

FIG. 10 illustrates an exemplary CCDF plot (1000) of DUC output at x2, in accordance with an embodiment of the present disclosure.

As illustrated in FIG. 10, the input signal may be upscaled to x4 using an FIR based interpolator for the PA to work at a high data rate and the PAPR of CFR output signal may signify the effect of interpolation. Further, the CCDF plot (1000) after DUC may be analyzed to observe a variation in the average power to the PA.

FIG. 11 illustrates an exemplary CCDF plot (1100) of DUC output at x4, in accordance with an embodiment of the present disclosure.

As illustrated in FIG. 11, the PAPR of signal output at both x2 DUC out and x4 DUC out may be analyzed. Hence, a peak regrowth may be observed after interpolation where the peak growth results in the high PAPR of the scaled and peak removed CFR output signal.

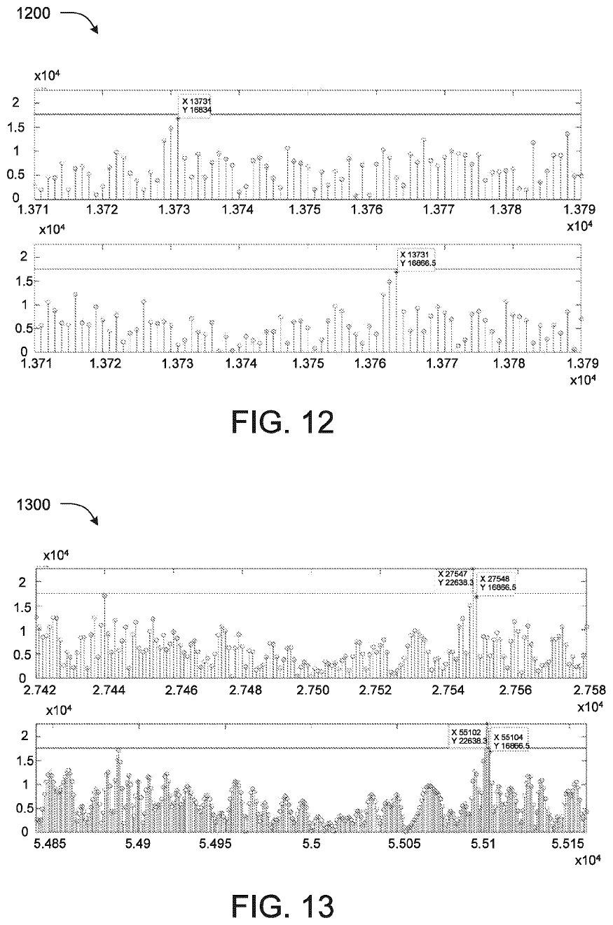

FIG. 12 illustrates an exemplary peak analysis (1200) with an input signal and output signal with CFR at x1, in accordance with an embodiment of the present disclosure.

As illustrated in FIG. 12, interpolation may upscale the input signal to a higher data rate. Further, additional two processes may be used as a first up sampling followed by FIR filtering. Up sampling may append zeroes in between the input signal to increase the data rate. Further, the filtering may further process the zeroes to a defined value. As shown in FIG. 12, the input sample at 13731 may be below the threshold and may be neglected by the peak detector (e.g., 404 or 702) while CFR processing. The output of the CFR may also be observed, as there is no change in the amplitude of the sample, the peak regrowth may not be dependent on the CFR processing. But after the x2 DUC output, the input signal shows an exponential growth in the amplitude, where the interpolation component of the input signal is showing the regrowth. The sample at 13763 in x1 has a peak raised adjacent component at 27547 at x2. This peak regrowth is observed due to the interpolation.

FIG. 13 illustrates an exemplary peak analysis (1300) at x2, x4 DUC outputs, in accordance with an embodiment of the present disclosure.

As illustrated in FIG. 13, the peak of the original signal at 13763 in x1 may not regrow as the magnitude of peak at 27548 is retained. Further, the calculation of the peak positions may be considered after taking the delay factor generated by the FIR filter in the interpolation. Hence, a delay of 11 samples may be observed with the required calculation [(13763+11)*2=27548]). The regrowth may not be detected by the CFR as the regrowth may only be observed after the DUC. However, the peaks may cause issues in both digital pre-distortion (DPD) and the PA, where the PA may be moved to a saturation region due to the high PAPR.

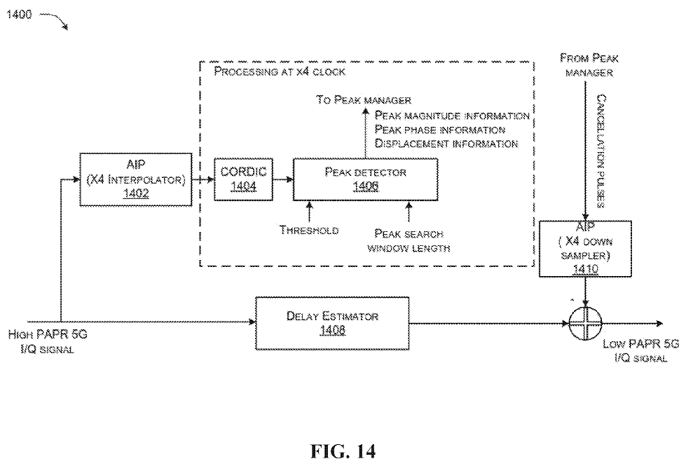

FIG. 14 illustrates an exemplary modified clip stage (1400) with an AIP module in the proposed CFR, in accordance with an embodiment of the present disclosure.

As illustrated in FIG. 14, instead of using an x1 signal, an x4 interpolated signal may be used directly at the CFR input to avoid the issue of regrowth. Using an x4 signal, the entire CFR module may work at a higher data rate which in turn may increase the hardware resources to go up by four times compared to a previous x1 design. Hence, a resource crunch in the FPGA module may be observed.

In an embodiment, an AIP interpolator (1402) may be introduced at the clip stage of the PC CFR module, as illustrated in FIG. 14. The AIP interpolator (1402) may bean x4 interpolator, where the input signal with a high PAPR may be fed directly to the x4 AIP interpolator (1402). The interpolated signal may be converted from a rectangular to a polar form using a CORDIC converter (1404). The x4 AIP interpolator (1402) may generate a peak regrowth that may be seen during up sampling of the input signal by the DUC. Further, multiple peaks may be detected by the peak detector module (1406). Further, the peak detector module (1406) may send a peak magnitude, a peak phase, and displacement information to a peak manager (e.g., 302). The peak manager (302) may generate the required cancellation pulses, where the cancellation pulses may be scaled to new peaks. A delay estimator (1408) may delay the unscaled original input signal. The cancellation pulses may affect the interpolated signal and the original input signal. The cancellation pulses may remove the peaks that have been generated by the interpolation. An AIP down sampler (1410) may be positioned to down sample the signal, i.e. from x4 to original x1 in order to subtract the interpolated signal from the original signal. The down sampler (1410) may be a simple module that picks actual x1 data samples and discards all the other data samples.

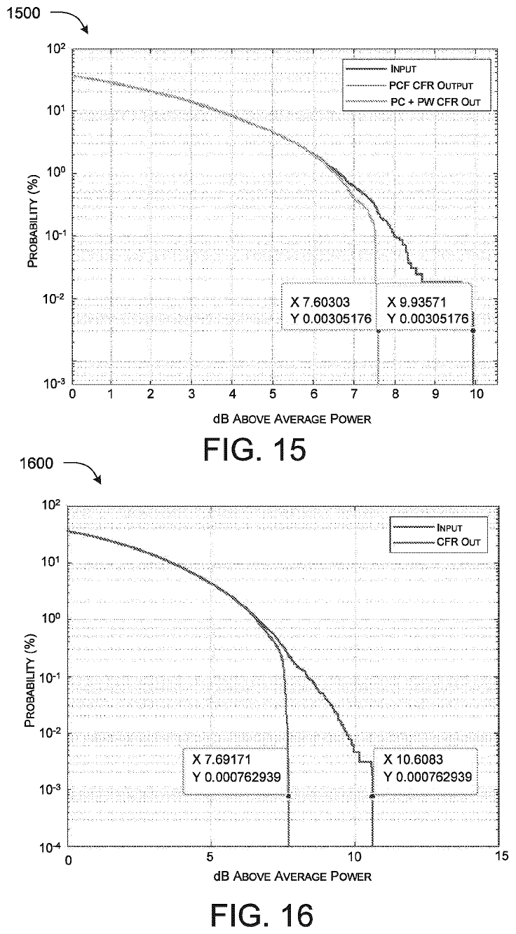

FIG. 15 illustrates an exemplary CCDF plot (1500) of CFR output at x1 with AIP, in accordance with an embodiment of the present disclosure.

As illustrated in FIG. 15, a variation in frequency (dB) over average power may be observed at x1 output with AIP.

FIG. 16 illustrates an exemplary CCDF plot (1600) of x4 DUC output with AIP, in accordance with an embodiment of the present disclosure.

As illustrated in FIG. 16, a variation in frequency (dB) over average power may be observed at x4 DUC output with AIP.

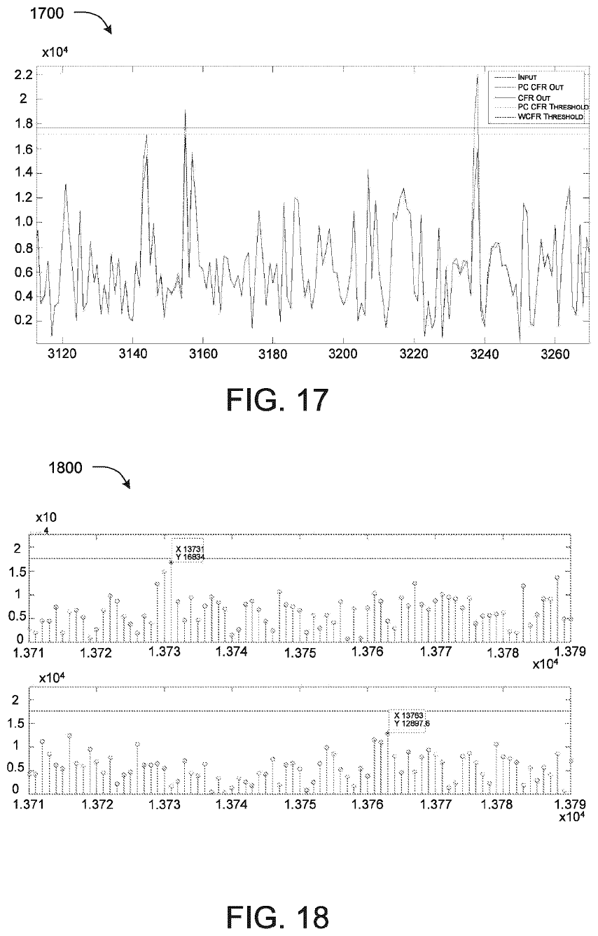

FIG. 17 illustrates an exemplary 5G signal comparison (1700) before and after CFR with AIP, in accordance with an embodiment of the present disclosure.

As illustrated in FIG. 17, a 5G signal comparison before and after CFR with AIP may be observed. Amplitude of various signals before and after CFR with AIP may be analyzed to observe a significant variation via AIP incorporation.

FIG. 18 illustrates an exemplary peak analysis (1800) of an input signal, output signal at x1 with AIP, in accordance with an embodiment of the present disclosure.

As illustrated in FIG. 18, by observing the input samples, a sample at 13731 may denote a value below the threshold level. Therefore, as the input signal is passed through the AIP module, the peak regrowth may be pre-determined and removed.

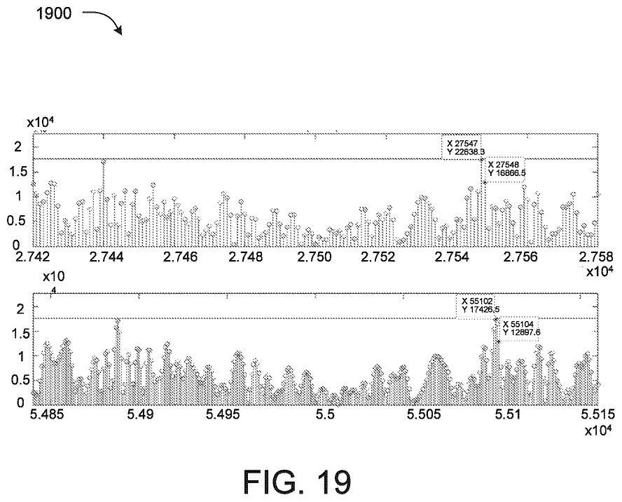

FIG. 19 illustrates an exemplary peak analysis (1900) at x2 DUC output and x4 DUC output with AIP, in accordance with an embodiment of the present disclosure.

As illustrated in FIG. 19, the sample at 13763 may possess an amplitude lesser than the input signal due to detection and removal of a peak component. An amplitude of the peak component may be reduced via AIP interpolation, thereby terminating any possibility for a peak regrowth in the x4 DUC.

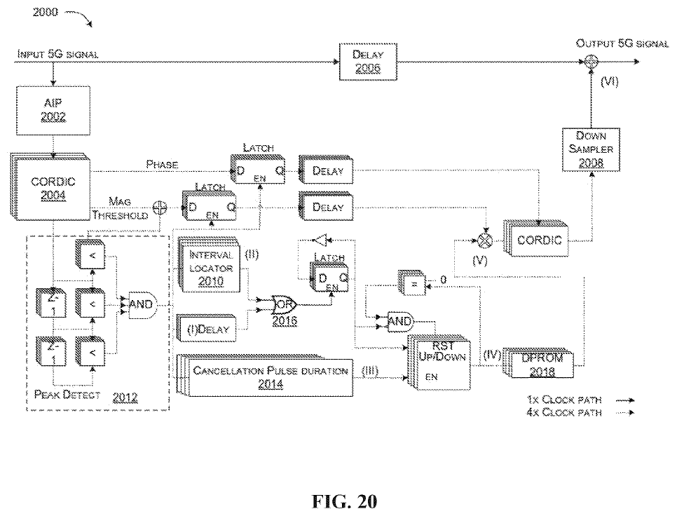

FIG. 20 illustrates an exemplary hardware block diagram (2000) of the AIP integrated CFR, in accordance with an embodiment of the present disclosure.

As illustrated in FIG. 20, a CORDIC (2004) may be used to compute the instantaneous magnitude and phase of an input 5G signal. A peak detector (2012) may include registers and comparators, and may output ‘1’ when a magnitude of a peak is found. The output of the peak detector (2012) may be connected to enable ports of the two latches that store the magnitude and phase of the corresponding peak. An interval locator block (2010) may generate an output ‘1’ between two peaks when the interval of the peaks is less than the cancelling-pulse length. Outputs of the peak detector (2012) and the interval locator block (2010) may be combined with an OR gate (2016). A delay block (2006) may be used to align these two signals as the interval locator block (2010) may possess a fixed delay. The cancellation pulse duration block (2014) may produce an enable signal for a counter that outputs the address of a dual ported-random access memory (DPRAM). The counting direction of the counter may be controlled by a latch output which is reversed by a triggered output of the OR gate (2016). Further, a DPROM (2018) may be scaled and rotated by a latched magnitude and phase to form the cancelling pulses. The smoothed cancelling pulses may be subtracted from the delayed original signal to form the PAPR reduced signal.

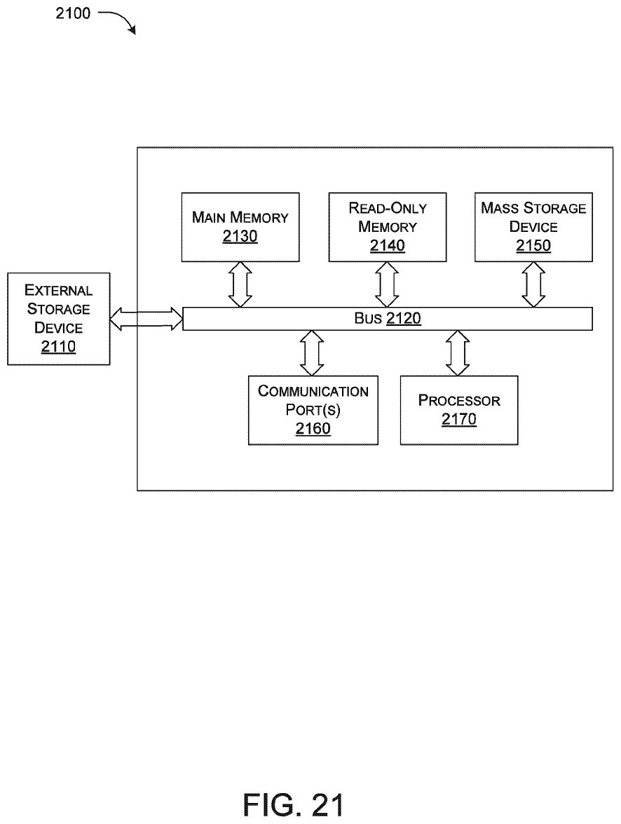

FIG. 21 illustrates an exemplary computer system (2100) in which or with which the proposed system may be implemented. In an embodiment, the system (110) may be implemented as the computer system (2100).

As shown in FIG. 21, the computer system (2100) may include an external storage device (2110), a bus (2120), a main memory (2130), a read-only memory (2140), a mass storage device (2150), a communication port(s) (2160), and a processor (2170). A person skilled in the art will appreciate that the computer system (2100) may include more than one processor and communication ports. The processor (2170) may include various modules associated with embodiments of the present disclosure. The communication port(s) (2160) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (2160) may be chosen depending on a network, such as a Local Area Network (LAN), Wide Area Network (WAN), or any network to which the computer system (2100) connects.

In an embodiment, the main memory (2130) may be Random Access Memory (RAM), or any other dynamic storage device commonly known in the art. The read-only memory (2140) may be any static storage device(s) e.g., but not limited to, a Programmable Read Only Memory (PROM) chip for storing static information e.g., start-up or basic input/output system (BIOS) instructions for the processor (2170). The mass storage device (2150) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (2120) may communicatively couple the processor(s) (2170) with the other memory, storage, and communication blocks. The bus (2120) may be, e.g. a Peripheral Component Interconnect PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (2170) to the computer system (2100).

In another embodiment, operator and administrative interfaces, e.g., a display, keyboard, and cursor control device may also be coupled to the bus (2120) to support direct operator interaction with the computer system (2100). Other operator and administrative interfaces can be provided through network connections connected through the communication port(s) (2160). Components described above are meant only to exemplify various possibilities. In no way should the aforementioned exemplary computer system (2100) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method with crest factor reduction (CFR) to be used before digital up-conversion (DUC) which can run at a lower data rate with minimum a peak regrowth (˜0.5 dB).

The present disclosure provides a system and a method with reduction in Field Programmable Gate Array (FPGA) resource utilization while implementing CFR at a lower data rate before DUC.

The present disclosure provides a system and a method that utilizes a dual port read-only memory (ROM) which helps in reducing the number of random-access memory (RAM) blocks to store cancellation pulse coefficients for multiple-input multiple-output (MIMO) chains.

The present disclosure provides a system and a method that utilizes a lesser number of resources for multiple MIMO chains.

The present disclosure provides a system and a method that operates multiple MIMO channels (4 channels in case of 4× operating clock) via multiplexing in time domain which reduces resource utilization.

We claim:

1. A crest factor reduction (CFR) system (110) with a restricted peak regrowth, the system (110) comprising:
a processor (202); and
a memory (204) operatively coupled with the processor (202), wherein said memory (204) stores instructions, which when executed by the processor (202), causes the processor (202) to:
receive a signal from a Physical layer (PHY) of a base station (112) equipped with orthogonal frequency division multiplexing (OFDM), wherein the received signal is based on a complex low peak to average power ratio (PAPR) signal;
interpolate the received signal to an n-factor to generate the received signal with a pre-determined peak regrowth;
generate one or more pulses to negate a peak associated with the pre-determined peak regrowth of the received signal to generate a modified n-factor signal; and
decimate the modified n-factor signal to generate a PAPR diminished signal prior to a digital up-conversion (DUC) and generate the CFR with the restricted peak regrowth.

2. The system (110) as claimed in claim 1, wherein the processor (202) is configured with a coordinate rotation digital computer (CORDIC) technique to determine a magnitude and a phase associated with the received signal.

3. The system (110) as claimed in claim 2, wherein the processor (202) is configured to generate a peak search window (PSW) associated with the magnitude and the phase of the received signal.

4. The system (110) as claimed in claim 3, wherein the processor (202) is configured with a peak cancellation (PC) technique that provides multiplexing of the received signal and generates the PSW.

5. The system (110) as claimed in claim 1, wherein the processor (202) is configured with an advanced interpolation processing (AIP) technique for the generation of the received signal with the pre-determined peak regrowth.

6. The system (110) as claimed in claim 5, wherein the AIP technique uses a Finite Impulse Response (FIR) based interpolator for the generation of the received signal with the pre-determined peak regrowth.

7. The system (110) as claimed in claim 1, comprising a down sampler for the decimation of the modified n-factor signal.

8. The system (110) as claimed in claim 7, wherein the down sampler subtracts the modified n-factor signal from the received signal for the generation of the PAPR diminished signal.

9. The system (110) as claimed in claim 1, wherein the processor (202) is configured with a window crest factor reduction (WCFR) technique to sanitize the negated peak associated with the received signal.

10. The system (110) as claimed in claim 9, wherein the processor (202) is configured with a dual port read only memory (DPROM) to store the sanitized negated peak.

11. A method for crest factor reduction (CFR) with a restricted peak regrowth, the method comprising:
receiving, by a processor (202) associated with a system (110), a signal from a Physical layer (PHY) of a base station (112) equipped with orthogonal frequency division multiplexing (OFDM), wherein the received signal is based on a complex low peak to average power ration (PAPR) signal;
interpolating, by the processor (202), the received signal to an n-factor for generating the received signal with a pre-determined peak regrowth;
generating, by the processor (202), one or more pulses to negate a peak associated with the pre-determined peak regrowth of the received signal for generating a modified n-factor signal; and
decimating, by the processor (202), the modified n-factor signal to generate a PAPR diminished signal prior to a digital up-conversion (DUC) and generating the CFR with the restricted peak regrowth.

12. The method as claimed in claim 11, comprising determining, by the processor (202), a magnitude and a phase associated with the received signal via a coordinate rotation digital computer (CORDIC) technique.

13. The method as claimed in claim 12, comprising generating, by the processor (202), a peak search window (PSW) associated with the magnitude and the phase of the received signal.

14. The method as claimed in claim 13, comprising multiplexing, by the processor (202), the received signal for generating the PSW via a peak cancellation (PC) technique.

15. The method as claimed in claim 11, comprising generating, by the processor (202), the received signal with the pre-determined peak regrowth with an advanced interpolation processing (AIP) technique.

16. A non-transitory computer readable medium comprising a processor with executable instructions, causing the processor to:
receive a signal from a Physical layer (PHY) of a base station (112) equipped with orthogonal frequency division multiplexing (OFDM), wherein the received signal is based on a complex low peak to average power ration (PAPR) signal;
interpolate the received signal to an n-factor to generate the received signal with a pre-determined peak regrowth;
generate one or more pulses to negate a peak associated with the pre-determined peak regrowth of the received signal to generate a modified n-factor signal; and
decimate the modified n-factor signal to generate a PAPR diminished signal prior to a digital up-conversion (DUC) and generate a crest factor reduction (CFR) with a restricted peak regrowth.
